(19) United States
(12) Patent Application Publication
(10) Pub. No.: US 2015/0371231 A1
(43) Pub. Date: Dec. 24, 2015

(54) METHOD AND SYSTEM FOR TEMPORARY REPLACEMENT OF REAL ACCOUNT NUMBERS

(71) Applicant: MasterCard International Incorporated, Purchase, NY (US)

(72) Inventor: Justin X. HOWE, San Francisco, CA (US)

(21) Appl. No.: 14/311,547

(22) Filed: Jun. 23, 2014

(51) Int. Cl. G06Q 20/40; G06Q 20/38; G06Q 20/34

(52) U.S. Cl. CPC G06Q 20/409; G06Q 20/354; G06Q 20/385

(57) ABSTRACT

A method for processing an account corresponding to a reported absent payment card includes: storing, in an account database, an account profile, wherein the account profile includes data related to a payment account and includes at least an account identifier; receiving, by a receiving device, a reporting of an absent payment card, wherein the reporting includes at least the account identifier associated with the absent payment card; identifying, by a processing device, a limited-use controlled payment number; mapping, in the account profile, the identified limited-use controlled payment number to the account identifier; storing, in the account profile, an indication of the included account identifier as being reported as being absent; and transmitting, by a transmitting device, the identified limited-use controlled payment number as a response to the received reporting.

### FIELD

The present disclosure relates to the temporary replacement of an absent payment card, specifically the use of controlled payment numbers to temporary replace a payment card that has been stolen, lost, left behind or otherwise absent.

### BACKGROUND

Due to the vast rewards that are offered with various types of payment cards, as well as both the convenience and added security of their use compared to cash, many consumers are using payment cards more and more to conduct transactions. In some cases, consumers are abandoning other forms of payment altogether, and conducting transactions solely using payment cards.

Unfortunately, there may be times where a consumer that is reliant on their payment card may find themselves without it. For example, the consumer's payment card may be stolen, lost, or may simply have been left at home when they went out for the day or otherwise absent when needed. During these times, if the consumer does not have an alternative payment method, the consumer may be wholly unable to purchase goods or services, or may turn to another payment source of funds. This may place the consumer in an unfortunate situation, such as needing gas for their car but being unable to purchase any or pay for alternative transportation home, or being at a lunch with others and discovering the absent payment card and being left to ask another person to cover their meal.

In instances where a payment card is discovered to be lost or stolen, consumers can often contact their issuer, who may immediately issue the consumer a replacement card. However, these processes often take a number of days, during which time the consumer may be left without the ability to purchase goods or services, particularly at the time when the consumer discovered the absent payment card. In instances where the payment card was inadvertently left behind, the consumer may have no remedy from their issuer, and may be forced to wait until they are able to reclaim their card. Unfortunately, as stated above, this may place the consumer in an unfortunate situation during the wait.

Thus, there is a need for a technical solution to quickly and conveniently provide a consumer having an absent payment card with a temporary replacement to act as an alternative payment method.

### SUMMARY

The present disclosure provides a description of systems and methods for processing an account corresponding to an absent payment card.

A method for processing an account corresponding to a reported absent payment card includes: storing, in an account database, an account profile, wherein the account profile includes data related to a payment account and includes at least an account identifier; receiving, by a receiving device, a reporting of an absent payment card, wherein the reporting includes at least the account identifier associated with the absent payment card; identifying, by a processing device, a limited-use controlled payment number; mapping, in the account profile, the identified limited-use controlled payment number to the account identifier; storing, in the account profile, an indication of the included account identifier as being reported as being absent; and transmitting, by a transmitting device, the identified limited-use controlled payment number as a response to the received reporting.

A system for processing an account corresponding to a reported absent payment card includes an account database, a receiving device, a processing device, and a transmitting device. The account database is configured to store an account profile, wherein the account profile includes data related to a payment account and includes at least an account identifier. The receiving device is configured to receive a reporting of an absent payment card, wherein the reporting includes at least the account identifier associated with the absent payment card. The processing device is configured to: identify a limited-use controlled payment number; map, in the account profile, the identified limited-use controlled payment number to the account identifier; and store, in the account profile, an indication of the included account identifier as being reported as being absent. The transmitting device is configured to transmit the identified limited-use controlled payment number as a response to the received reporting.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for the processing of an account corresponding to an absent payment card in accordance with exemplary embodiments.

FIG. 2 is a block diagram illustrating the processing server of FIG. 1 for the temporary replacement of an absent payment card and processing thereof in accordance with exemplary embodiments.

FIG. 3 is a flow diagram illustrating a process for the processing of payment transactions using a temporary replacement payment card using the system of FIG. 1 in accordance with exemplary embodiments.

FIG. 4 is a flow diagram illustrating an alternative process for the processing of a payment transaction using a temporary replacement payment card in accordance with exemplary embodiments.

FIG. 5 is a flow chart illustrating a process for the temporary replacement of an absent payment card and processing thereof using the processing server of FIG. 2 in accordance with exemplary embodiments.

FIG. 6 is a flow chart illustrating an exemplary method for processing an account corresponding to an absent payment card in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, virtual payment account, etc. A payment account may be associated with a consumer, which may be any suitable type of entity associated with a payment account, which may include a person, family, company, corporation, governmental entity, etc. In some instances, a payment account may be virtual, such as those accounts operated by PayPal®, etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

Controlled Payment Number—Controlled payment numbers may be payment numbers associated with a payment account that are subject to one or more rules. In many cases, these rules may be set by a cardholder, such as spending limits, limits on days and/or times of a transaction, limits on merchants or industries, transaction spending or frequency limits, etc. Controlled payment numbers may offer an account holder an opportunity to give payment cards tied to the account to others for use, but subject to rules set by the cardholder, such as an employer distributing cards to employees, or a parent distributing cards to children. Additional detail regarding controlled payment numbers may be found in U.S. Pat. No. 6,636,833, issued Oct. 21, 2003; U.S. Pat. No. 7,136,835, issued Nov. 14, 2006; U.S. Pat. No. 7,571,142, issued Aug. 4, 2009; U.S. Pat. No. 7,567,934, issued Jul. 28, 2009; U.S. Pat. No. 7,593,896, issued Sep. 22, 2009; U.S. patent application Ser. No. 12/219,952, filed Jul. 30, 2008; U.S. patent application Ser. No. 12/268,063, filed Nov. 10, 2008; and U.S. patent application Ser. No. 12/359,971, filed Jan. 26, 2009; each of which are herein incorporated by reference in their entirety.

### System for Processing Accounts for Absent Payment Cards

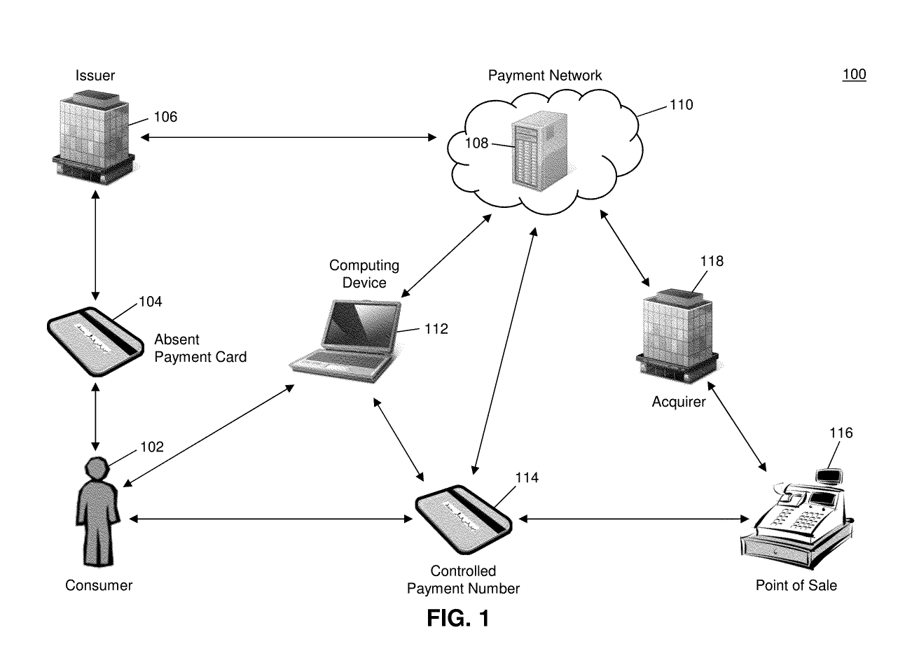

FIG. 1 illustrates a system 100 for the processing of accounts corresponding to absent payment cards and the processing of payment transactions based thereon.

The system 100 may include a consumer 102. The consumer 102 may have a payment card 104 issued to the consumer 102 from an issuer 106, which may be any type of financial institution that issues payment cards to consumers, such as an issuing bank. The payment card 104 may be associated with a payment account held by the issuer 106 and associated with the consumer 102, such as a credit card account.

As part of the issuing of the payment card 104 to the consumer 102, the issuer 106 may transmit account data for the corresponding payment account to a processing server 108. The processing server 108, discussed in more detail below, may be part of a payment network 110 configured to process payment transactions. The processing server 108 may store an account profile for the payment account, which may include at least the payment account number, such as is encoded in the payment card 104 issued to the consumer 102.

The consumer 102 may discover that the payment card 104 is absent for one reason or another. For instance, the payment card 104 may have been lost or stolen, the consumer 102 may have left the payment card 104 at home or work, the payment card 104 may have been borrowed by a family member and not returned, etc. In any case, the payment card 104 may be absent and therefore unable to be used by the consumer 102 to fund a payment transaction.

Once the consumer 102 discovers that the payment card 104 is absent, the consumer 102 may use a computing device 112 to communicate with the processing server 108 of the payment network 110 to report the payment card 104 as being absent. The consumer 102 may report the absent payment card 104 using an application program executed by the computing device 112 and/or processing server 108, via a webpage hosted by or on behalf of the processing server 108, via e-mail, a telephone call, a short message service (SMS) message, a multimedia message service (MMS) message, or any other suitable method that will be apparent to persons having skill in the relevant art. The computing device 112 may be any type of computing device suitable for enabling the consumer 102 to report the absent payment card 104 to the processing server 108, such as a desktop computer, laptop computer, notebook computer, tablet computer, smart phone, cellular phone, smart television, personal digital assistant, smart watch, etc.

The processing server 108 may receive the reporting of the absent payment card 104, and may identify a controlled payment number (CPN) 114 to issue to the consumer 102 to be used in place of the absent payment card 104. The CPN 114 may be a limited use payment account number that may be used by the consumer 102 while waiting for the absent payment card 104 to be recovered and/or replaced. The CPN 114 may be a virtual payment card distributed to the computing device 112, may be a physical card distributed directly to the consumer 102 (e.g., and printed by the computing device 112, such as an automated teller machine), a combination thereof, or any other type of form suitable for use in engaging in payment transactions.

The consumer 102 may then take the CPN 114 to a merchant point of sale 116 for use in funding a payment transaction at the corresponding merchant. In embodiments where the CPN 114 may be a virtual payment card, the consumer 102 may present the computing device 112 or other suitable computing device that stores the issued CPN 114 to the point of sale 116. The point of sale 116 may read the payment details of the CPN 114, or the payment details for the CPN 114 may be input into the point of sale 116 (e.g., by an employee of the merchant, the consumer 102, etc.), and the point of sale 116 may initiate processing of a payment transaction using the CPN 114.

In some embodiments, processing of the payment transaction may include transaction details for the payment transaction, including payment details of the CPN 114, being transmitted to an acquirer 118 associated with the point of sale 116, such as an acquiring bank. The acquirer 118 may then generate an authorization request for the payment transaction and submit the request to the payment network 110. The processing server 108 may receive the authorization request for the payment transaction, and may identify the CPN 114 as being used to fund the transaction.

The processing server 108 may identify if the transaction satisfies any limits placed on the CPN 114, and, if the limits are satisfied, may swap the CPN 114 for the payment account number associated with the absent payment card 104 and process the payment transaction using traditional systems and methods for transaction processing. Once the transaction has been processed, an authorization response indicating approval or denial of the payment transaction may be transmitted to the acquirer 118 for forwarding to the point of sale 116, and the transaction finalized accordingly.

As indicated above, one or more limits may be placed on the CPN 114, such that the CPN 114 may be a limited-use controlled payment number. Limits placed on the CPN 114 may include transaction limits (e.g., single-use), transaction amount limits (e.g., only transactions below $20), merchant limits (e.g., only at specified merchants and/or merchant categories), geographic limits (e.g., only for merchants in a specified area), and other limits that will be apparent to persons having skill in the relevant art. In some instances, the limits may be based on the consumer 102 and/or transaction history of the consumer 102. For example, the CPN 114 may be limited to regular merchants visited by the consumer 102, such as a usual lunch spot, gas station, or coffee house. In such an instance, the limits may be used to prevent fraud, such as by a nefarious third party that reports the payment card 104 as absent to gain access to a CPN 114 for the account.

In some embodiments, the CPN 114 may have limits based on the reporting made by the consumer 102. For example, if the consumer 102 reports the payment card 104 as left behind and that it will be recovered in less than 10 hours (e.g., the consumer 102 left the payment card 104 at home when they left for work), then the CPN 114 may be limited to a 10 hour period, and may be further limited based on instructions provided by the consumer 102. For instance, the consumer 102 may request a single-use CPN 114 with a limit of $50 to be used for lunch during their work day until they are able to go home and recover the payment card 104. Once the consumer 102 recovers the payment card 104, they may notify the processing server 108 (e.g., via the computing device 112). The processing server 108 can then deactivate the CPN 114 and begin to process payment transactions using the payment card 104 as normal.

In some instances, the processing server 108 may be configured to notify the issuer 106 once the payment card 104 has been reported by the consumer 102 as being absent. In some cases, the reporting may only be performed if the payment card 104 has been reported as being lost or stolen, or if the consumer 102 has otherwise indicated that a replacement payment card needs to be issued. In such an instance, the consumer 102 may be able to receive a temporary CPN 114 and also initiate the cancellation of the absent payment card 104 and processing for a new payment card in a single action, without the need to deal with multiple entities.

By using the CPN 114 to temporarily replace the absent payment card 104, and by placing limits on the use of the CPN 114, the processing server 108 may be able to provide the consumer 102 with the ability to continue to conduct necessary payment transactions even when a payment card 104 has been lost, stolen, left behind, or is otherwise unavailable. In addition, the ability for the details of the CPN 114 to be provided to the consumer 102 in a variety of forms, such as via the computing device 112, via a printout with the payment details included thereon, etc., may enable the consumer 102 to easily use the CPN 114 as a replacement for the absent payment card 104. For example, the consumer 102 may discover that the payment card 104 is absent when at a restaurant and needing to pay for a meal. The consumer 102 may use a smart phone to report the payment card 104 as absent and receive the CPN 114. The consumer 102 can then provide the CPN 114 details to the restaurant using the smart phone and pay for the transaction without skipping a beat.

Furthermore, by placing limits on the CPN 114, the processing server 108 may be able to provide convenience and peace of mind to the consumer 102, while maintaining a high level of security over the consumer's 102 account. For instance, if limits are placed on the CPN 114 that require it to be used at merchants regularly visited by the consumer 102 and for regular transaction amounts, a nefarious party who gains access to the CPN 114 may be unable to use the CPN 114 for any detrimental transactions (e.g., large purchases, exotic purchases, etc.), due to the limits placed on the CPN 114. In addition, the ability for the processing server 108 to communicate with the issuer 106 to initiate replacement of a lost or stolen payment card 104 may provide further convenience to the consumer 102.

### Processing Server

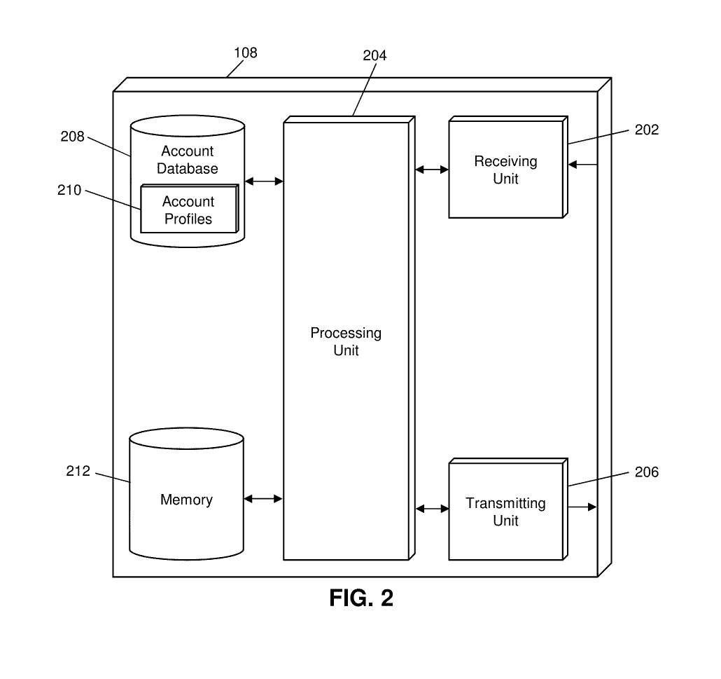

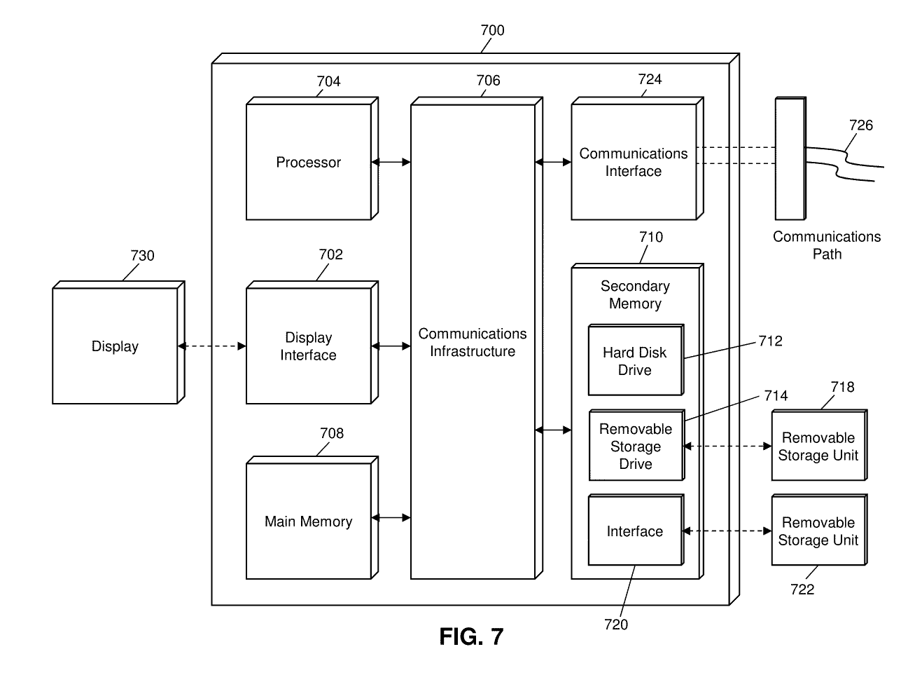

FIG. 2 illustrates an embodiment of the processing server 108 of the system 100. It will be apparent to persons having skill in the relevant art that the embodiment of the processing server 108 illustrated in FIG. 2 is provided as illustration only and may not be exhaustive to all possible configurations of the processing server 108 suitable for performing the functions as discussed herein. For example, the computer system 700 illustrated in FIG. 7 and discussed in more detail below may be a suitable configuration of the processing server 108.

The processing server 108 may include an account database 208. The account database 208 may be configured to store a plurality of account profiles 210. Each account profile 210 may be configured to store data related to a payment account including at least an account identifier. The account identifier may be a value suitable for identification of the respective account profile 210 and/or related payment account, such as a payment account number (e.g., associated with the payment card 104), identification number, username, e-mail address, phone number, street, address, or any other suitable value that will be apparent to persons having skill in the relevant art.

The processing server 108 may also include a receiving unit 202 that may be configured to receive data over one or more networks via one or more network protocols. The receiving unit 202 may receive account data from the issuer 106, which may be stored in the account database 208 as the account profiles 210. For example, the issuer 106 may transmit the account number for a newly issued payment card 104 to the processing server 108, which may be received by the receiving unit 202 and stored as a new account profile 210 including the account number.

Each account profile 210 may also include additional account data, which may be provided by the issuer 106, the consumer 102 related to the account profile 210, the payment network 110, or from any other suitable entity. In one embodiment, each account profile 210 may include transaction data for a plurality of payment transactions involving the related payment account, which may be captured by the processing server 108 and/or payment network 110 during transaction processing, and may be used for the identification of limits to be placed on an issued CPN 114.

The receiving unit 202 may be further configured to receive a report of an absent payment card 104. The received report may include at least the account identifier (e.g., the payment account number) associated with the absent payment card 104. In some instances, the report may also include an indication of the absent payment card 104 as being lost, stolen, or left behind, and instruction to notify the issuer 106 of the absent payment card 104, criteria for a CPN 114, and/or any other useful data.

The processing server 108 may also include a processing unit 204. The processing unit 204 may be configured to perform the functions of the processing server 108 discussed herein as will be apparent to persons having skill in the relevant art. The processing unit 204 may be configured to identify a specific account profile 210 that includes an account identifier that is included in a received report of an absent payment card 104. The processing unit 204 may be further configured to identify a CPN 114 for the related payment account. In some embodiments, the processing unit 204 may identify limits to be placed on the CPN 114, such as based on account data included in the specific account profile 210. The processing unit 204 may be configured to update the specific account profile 210 to include the CPN 114 and any identified limits.

The processing server 108 may further include a transmitting unit 206. The transmitting unit 206 may be configured to transmit data over one or more networks via one or more network protocols. The transmitting unit 206 may transmit the identified CPN 114 to the consumer 102. In some embodiments, the CPN 114 may be transmitted to the computing device 112 used to submit the report. In other embodiments, the CPN 114 may be transmitted to a computing device and/or in a method identified by the consumer 102, such as stored in the account profile 210 or included in the submitted report. In some embodiments, the transmitting unit 206 may be configured to transmit a message to the issuer 106 indicating that the absent payment card 104 has been lost or stolen.

The receiving unit 202 may be further configured to receive an authorization request for a payment transaction. The authorization request may include an account identifier, a transaction amount, and any other transaction data suitable for performing the functions disclosed herein, such as a merchant identifier, merchant category, product data, transaction time and/or date, geographic location, etc. The processing unit 204 may be configured to identify an account profile 210 that includes the account identifier included in the received authorization request. The processing unit 204 may then process the payment transaction accordingly, such as by determining if a valid account number was used in the transaction. As discussed in more detail below, determining validity may include identifying if a CPN 114 satisfies limits, or identifying if a payment card 104 associated with an account number has been reported as absent.

The processing server 108 may also include a memory 212. The memory 212 may be configured to store data suitable for performing the functions disclosed herein, such as program code for the identification of CPNs 114, for the generation and usage of limits on CPNs 114, for the processing of payment transactions, etc.

It will be apparent to persons having skill in the relevant art that each of the components of the processing server 108 discussed herein may be further configured to perform additional functions as necessary for performing the functions disclosed herein, as well as the traditional functions of a payment network 110, such as the processing of payment transactions. Additional components that may be included in the processing server 108 for use in performing the functions disclosed herein and/or traditional functions of a payment network 110 will also be apparent to persons having skill in the relevant art.

### Processing Payment Transactions Using a Replacement Payment Number

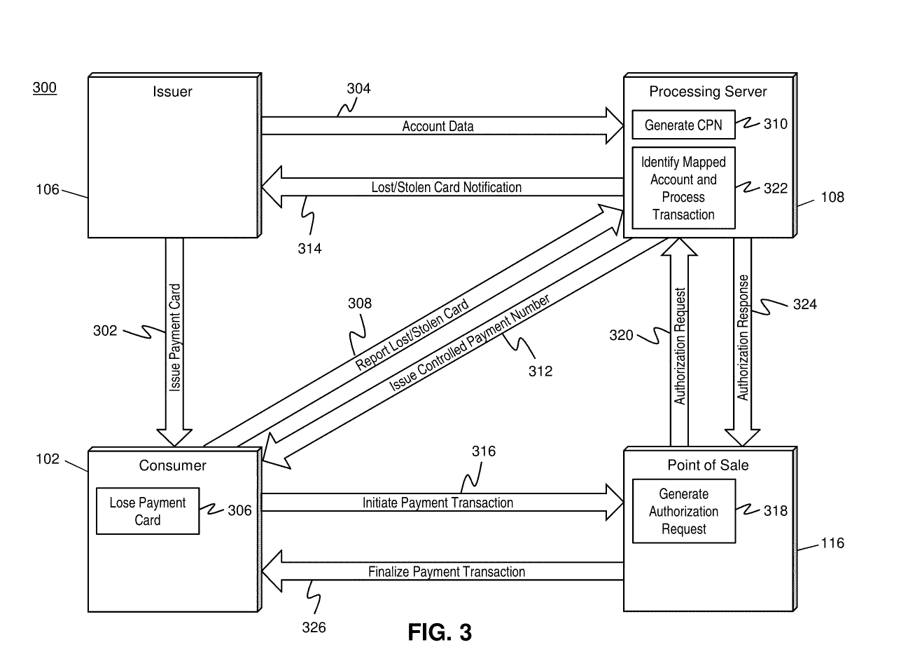

FIG. 3 illustrates a process 300 for the processing of payment transactions using a CPN 114 issued to the consumer 102 due to an absent payment card 104.

In step 302, the issuer 106 may issue the payment card 104 to the consumer 102. The payment card 104 may be encoded with an account identifier, such as a payment account number, corresponding to a payment account to which the payment card 104 is associated. In step 304, the issuer 106 may transmit account data associated with the corresponding payment account and/or payment card 104 to the processing server 108 (e.g., for storage in the account database 208).

In step 306, the consumer 102 may lose, or have stolen, the issued payment card 104. In step 308, the consumer 102 may submit a report (e.g., via the computing device 112) for the payment card 104 to report it as lost or stolen. The receiving unit 202 of the processing server 108 may receive the report, and, in step 310, the processing unit 204 may identify or generate a CPN 114 for use by the consumer 102. Generation of the CPN 114 may include identifying one or more limits to be placed on the CPN 114, and mapping of the CPN 114 to the account number associated with the issued payment card 104.

In step 312, the transmitting unit 206 of the processing server 108 may transmit the CPN 114 to the consumer 102 (e.g., via the computing device 112). In step 314, the transmitting unit 206 may transmit a notification of the issued payment card 104 as being reported as lost or stolen by the consumer 102. It will be apparent to persons having skill in the relevant art that step 314 may be an optional step.

In step 316, the consumer 102 may initiate a payment transaction with a merchant at a merchant point of sale 116. As part of the initiation of the payment transaction, the consumer 102 may present the CPN 114 for payment. In step 318, the point of sale 116 (e.g., or the acquirer 118 based on data received from the point of sale 116) may generate an authorization request for the payment transaction, which may include the CPN 114 and any other necessary transaction data. In step 320, the authorization request may be submitted to the processing server 108 and received by the receiving unit 202.

In step 322, the processing unit 204 may identify the account number of the payment card 104 that is mapped to the CPN 114 used in the payment transaction, and may process the payment transaction using the mapped account number. The processing of the payment transaction may be using traditional methods and systems that are apparent to persons having skill in the relevant art. In instances where the CPN 114 may include one or more limits, the processing of the payment transaction may only be performed if the one or more limits are satisfied.

In step 324, the transmitting unit 206 may transmit an authorization response to the point of sale 116 (e.g., via the acquirer 118) indicating approval or denial of the payment transaction. In step 326, the point of sale 116 (e.g., and a user of the point of sale 116, such as an employee) may finalize the payment transaction with the consumer 102, such as by furnishing the consumer 102 with the transacted-for goods and/or services.

### Alternative Processing of a Payment Transaction Using a Replacement Payment Number

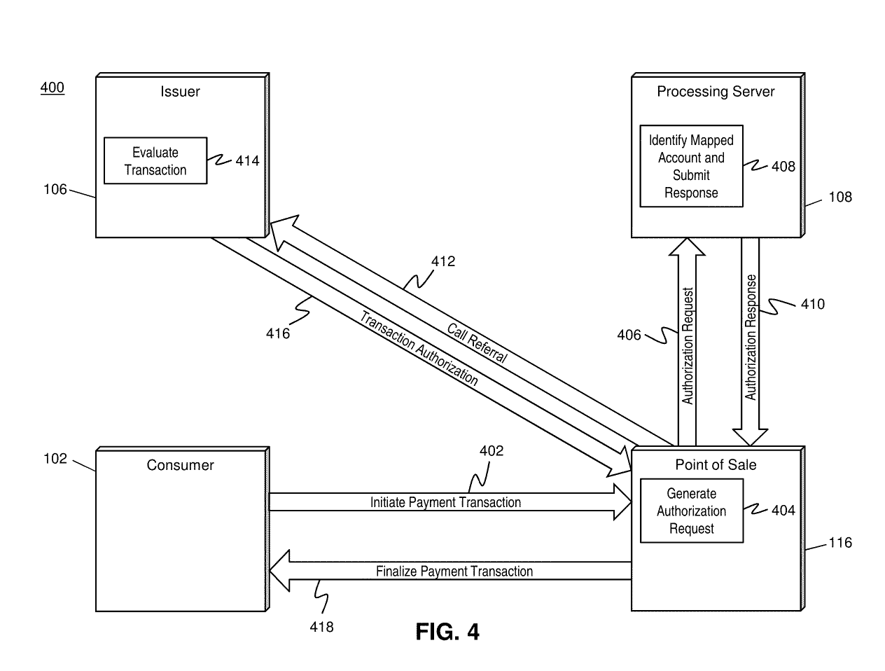

FIG. 4 illustrates an alternative method 400 for the processing of payment transactions using a CPN 114 due to a reported absent payment card 104.

In step 402, the consumer 102 may initiate a payment transaction at the point of sale 116, which may include providing the CPN 114 to the point of sale 116 for use in funding the payment transaction. In step 404, the point of sale 116 (e.g., or an acquirer 118 using transaction data supplied by the point of sale 116) may generate an authorization request for the payment transaction. The authorization request may include at least the CPN 114 and any other necessary transaction data. In step 406, the authorization request may be submitted to the processing server 108 and received by the receiving unit 202 of the processing server 108.

In step 408, the processing unit 204 of the processing server 108 may identify the account profile 210 stored in the account database 208 that includes the CPN 114 included in the authorization request and may identify the payment account number (e.g., corresponding to the payment card 104) mapped to the CPN 114 in the account profile 210. The processing unit 204 may then generate an authorization response that may include the mapped payment account number as well as a data field indicating that a call referral to the issuer 106 is necessary to process the transaction. In step 410, the transmitting unit 206 of the processing server 108 may transmit the authorization response to the point of sale 116.

The point of sale 116 may receive the response, and, in step 412, may initiate the call referral with the issuer 106. The call referral may be a call from the point of sale 116 (e.g., or the acquirer 118 associated with the point of sale 116) to the issuer 106 for further instructions with regards as to how to proceed with the payment transaction. As part of the call referral, the mapped payment account number and any necessary transaction data (e.g., transaction amount, merchant identifier, etc.) may be provided to the issuer 106. In step 414, the issuer 106 may evaluate the payment transaction to determine if the transaction should be approved or denied based on the received information and any other suitable criteria that will be apparent to persons having skill in the relevant art, such as fraud rules and algorithms.

If the transaction is suitable for approval to the issuer 106, then, in step 416, the issuer 106 may provide approved authorization for the payment transaction to the point of sale 116. With the approval received, in step 418, the point of sale 116 may finalize the payment transaction with the consumer 102. The use of the call referral in the method 400 may be an additional or alternative security measure used in the processing of payment transactions using a CPN 114 issued due to an absent payment card 104. For example, in some instances, the CPN 114 may have limits that must be met in addition to the issuer 106 needing to separately approve the transaction via the call referral. Call referrals may occur at the behest of the issuer 106, the point of sale 116, the acquirer 118, or the payment network 110. For instance, the processing unit 204 may determine if a call referral is necessary based on transaction data included in the received authorization request, such as the transaction amount being above a predetermined amount.

### Processing Replacement Payment Numbers and Corresponding Transactions

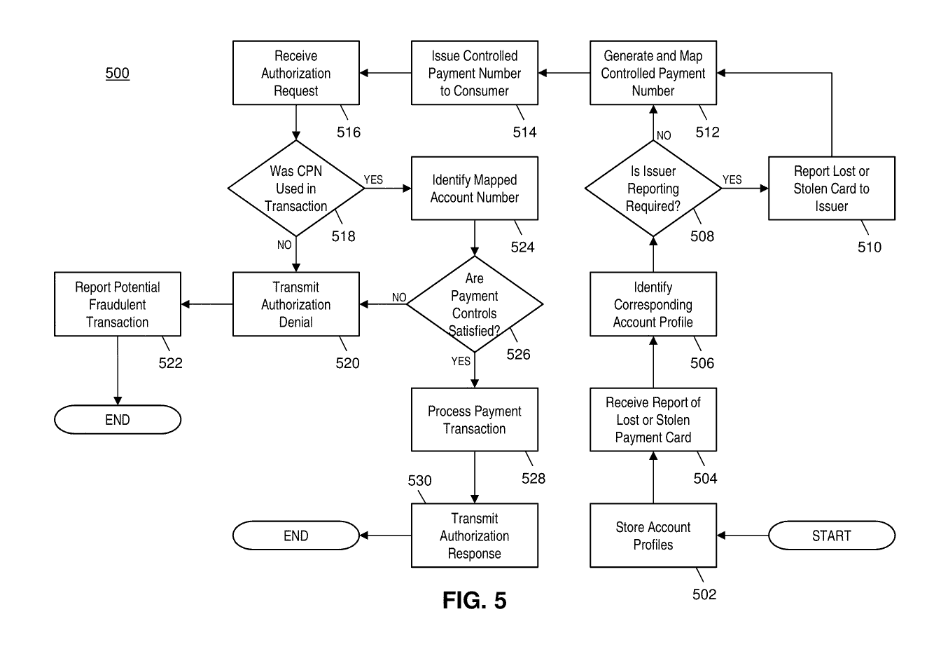

FIG. 5 illustrates a method 500 for the processing of CPNs 114 as replacements for absent payment cards 104 and the processing of payment transactions corresponding to the payment account associated with the absent payment card 104.

In step 502, the processing server 108 may store a plurality of account profiles 210 in the account database 208. Each account profile may include at least an account identifier associated with a payment card 104 and any other additional account data. In step 504, the receiving unit 202 of the processing server 108 may receive a report of a lost or stolen payment card 104. The report may include at least the account identifier associated with the payment card 104 being reported as lost or stolen.

In step 506, the processing unit 204 may identify a specific account profile 210 in the account database 208 corresponding to the lost or stolen payment card 104 based on a correspondence between the account identifier included in the specific account profile 210 and the account identifier included in the received report. In step 508, the processing unit 204 may determine if the issuer 106 of the lost or stolen payment card 104 is required to receive a reporting of the payment card 104 being lost or stolen. The determination may be based on the issuer 106 of the payment card 104 and any suitable criteria, such as issuer instructions, consumer instructions (e.g., included in the report), payment network 110 policy, etc. If the issuer 106 is to be notified, then, in step 510, the transmitting unit 206 of the processing server 108 may transmit a notification to the issuer 106 that includes at least the account identifier included in the received report and the indication of the payment card 104 as being lost or stolen.

Following the reporting, or if no reporting was required, in step 512, the processing unit 204 may generate a CPN 114 to be associated with the lost or stolen payment card 104 and may associate the CPN 114 with the specific account profile 210 in the account database 208. In some embodiments, the processing unit 204 may identify one or more limits to be placed on the generated CPN 114, such as based on account data included in the specific account profile 210. In step 514, the transmitting unit 206 may transmit the generated CPN 114 to the consumer 102 (e.g., via the computing device 112 or other suitable method). The consumer 102 may then conduct a payment transaction in the normal course. In step 516, the receiving unit 202 of the processing server 108 may receive an authorization request for a payment transaction involving the consumer 102. The authorization request may include at least an account number, a transaction amount, and any other required transaction data.

In step 518, the processing unit 204 may determine if the payment account number used in the transaction, as included in the authorization request, is the CPN 114. If the CPN 114 was not used, such as if the consumer 102 (e.g., or a nefarious third party) used the reported lost or stolen payment card 104, then, in step 520, the transmitting unit 206 may transmit an authorization response indicating denial of the transaction back to the point of sale 116. In step 522, the transmitting unit 206 may transmit a report of the attempted fraudulent transaction to the issuer 106. The report may include details of the transaction, such as the transaction data included in the authorization request. For example, the processing server 108 may report the time, location, amount, and merchant of the attempted transaction.

If, in step 518, the processing unit 204 determines that the CPN 114 was used in the transaction, then, in step 524, the processing unit 204 may identify the specific account profile 210 that includes the CPN 114 and the mapped account identifier corresponding to the lost or stolen payment card 104. In step 526, the processing unit 204 may determine if any limits or controls placed on the CPN 114 are met, based on analysis of the transaction data included in the received authorization request. If the controls or limits are not satisfied, then the process 500 may proceed to step 520 where the transaction is denied and the attempted transaction reported to the issuer 106.

If the payment controls or limits are satisfied, then, in step 528, the processing unit 204 may process the payment transaction using the original account identifier using methods and systems that will be apparent to persons having skill in the relevant art. In step 530, the transmitting unit 206 may transmit an authorization response for the payment transaction to the point of sale 116 in response to the received authorization request, with the authorization response indicating approval or denial of the payment transaction based on the results of the transaction processing.

### Exemplary Method for Processing an Account Corresponding to a Reported Absent Payment Card

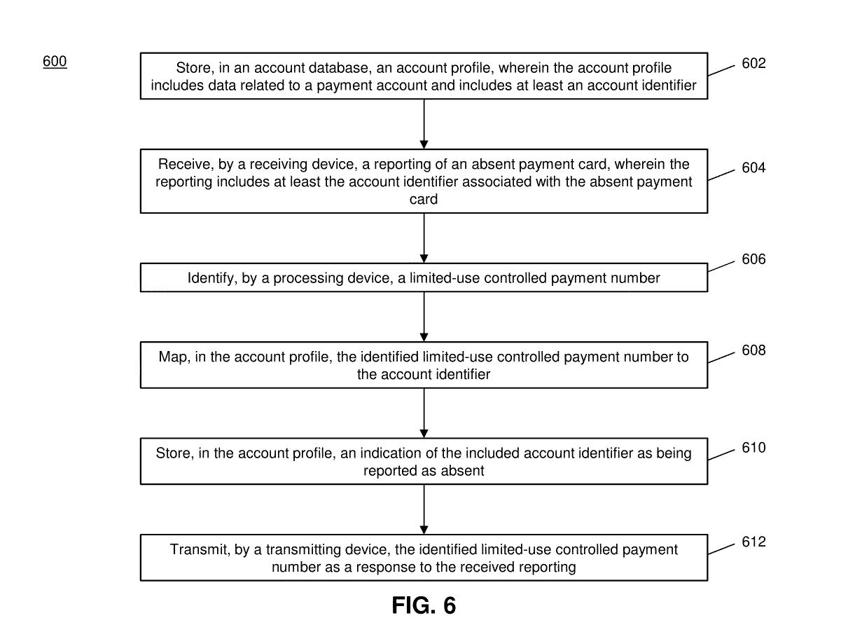

FIG. 6 illustrates a method 600 for the processing of an account corresponding to a reportedly absent payment card by the identification and issuance of a controlled payment number.

In step 602, an account profile (e.g., the account profile 210) may be stored in an account database (e.g., the account database 208), wherein the account profile 210 includes data related to a payment account and includes at least an account identifier. In step 604, a reporting of an absent payment card (e.g., the payment card 104), may be received by a receiving device (e.g., the receiving unit 202), wherein the reporting includes at least the account identifier associated with the absent payment card 104. In one embodiment, the received reporting may further include an indication of the absent payment card 104 as being one of: (i) lost, (ii) stolen, and (iii) left behind.

In step 606, a limited-use controlled payment number (CPN) (e.g., the CPN 114) may be identified by a processing device (e.g., the processing unit 204). In one embodiment, the limited-use CPN 114 may be limited in use by at least one of: transaction amount, merchant identification number, merchant category, geographic location, transaction time and/or date, number of transactions, and product data. In some embodiments, the account profile 210 may further include transaction history associated with the related payment account, and the limited-use CPN 114 may be subject to one or more controls that are based on at least the transaction history included in the account profile 210.

In step 608, the identified limited-use CPN 114 may be mapped to the account identifier in the account profile 210. In step 610, an indication of the included account identifier as being reported as absent may be stored in the account profile 210. In step 612, the identified limited-use CPN 114 may be transmitted, by a transmitting device (e.g., the transmitting unit 206), as a response to the received reporting.

In one embodiment, the method 600 may further include: receiving, by the receiving device 202, an authorization request for a payment transaction, wherein the authorization request includes the account identifier associated with the absent payment card 104; and transmitting, by the transmitting device 206, an authorization response indicating denial of the payment transaction. In another embodiment, the method 600 may further include: receiving, by the receiving device 202, an authorization request for a payment transaction, wherein the authorization request includes the limited-use CPN 114 and transaction data; and processing, by the processing device 204, the payment transaction using the identified account identifier mapped to the limited-use CPN 114.

In some embodiments, the method 600 may further include: receiving, by the receiving device 202, an authorization request for a payment transaction, wherein the authorization request includes the identified limited-use CPN 114; and transmitting, by the transmitting device 206, a data signal configured to initiate a call between a merchant involved in the payment transaction and a financial institution associated with the account identifier. In a further embodiment, the transmitted data signal may be an authorization request including a data field indicating that the call between the merchant and the financial institution is required for authorization. In another further embodiment, the call may be a telephone call.

In embodiments where the reporting may include an indication of the absent payment card 104 as being stolen, the method 600 may further include transmitting, by the transmitting device 106, a data message to a financial institution associated with the absent payment card 104 indicating theft of the payment card 104. In some embodiments, the method 600 may also include: receiving, by the receiving device 202, an indication that the absent payment card 104 has been recovered; and removing, from the account profile 210, the mapped limited-use CPN 114 such that the limited-use CPN 114 is disabled from use in a payment transaction.

### Computer System Architecture

FIG. 7 illustrates a computer system 700 in which embodiments of the present disclosure, or portions thereof, may be implemented as computer-readable code. For example, the processing server 108 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for processing accounts corresponding to reported absent payment cards. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for processing an account corresponding to a reported absent payment card, comprising:
storing, in an account database, an account profile, wherein the account profile includes data related to a payment account and includes at least an account identifier;
receiving, by a receiving device, a reporting of an absent payment card, wherein the reporting includes at least the account identifier associated with the absent payment card;
identifying, by a processing device, a limited-use controlled payment number;
mapping, in the account profile, the identified limited-use controlled payment number to the account identifier;
storing, in the account profile, an indication of the included account identifier as being reported as being absent; and
transmitting, by a transmitting device, the identified limited-use controlled payment number as a response to the received reporting.

2. The method of claim 1, further comprising:
receiving, by the receiving device, an authorization request for a payment transaction, wherein the authorization request includes the account identifier associated with the absent payment card; and
transmitting, by the transmitting device, an authorization response indicating denial of the payment transaction.

3. The method of claim 1, further comprising:
receiving, by the receiving device, an authorization request for a payment transaction, wherein the authorization request includes the identified limited-use controlled payment number and transaction data; and
processing, by the processing device, the payment transaction using the identified account identifier mapped to the limited-use controlled payment number.

4. The method of claim 1, further comprising:
receiving, by the receiving device, an authorization request for a payment transaction, wherein the authorization request includes the identified limited-use controlled payment number; and
transmitting, by the transmitting device, a data signal configured to initiate a call between a merchant involved in the payment transaction and a financial institution associated with the account identifier.

5. The method of claim 4, wherein the transmitted data signal is an authorization request including a data field indicating that the call between the merchant and the financial institution is required for authorization.

6. The method of claim 1, wherein the received reporting further includes an indication of the absent payment card as being one of: (i) lost, (ii) stolen, and (iii) left behind.

7. The method of claim 6, further comprising:
transmitting, by the transmitting device, a data message to a financial institution associated with the absent payment card indicating theft of the payment card if the reporting includes an indication of the payment card as being stolen.

8. The method of claim 1, wherein the limited-use controlled payment number is limited in use by at least one of: transaction amount, merchant identification number, merchant category, geographic location, transaction time and/or date, number of transactions, and product data.

9. The method of claim 1, wherein
the account profile further includes transaction history associated with the related payment account, and
the limited-use controlled payment number is subject to one or more controls, the one or more controls being based on at least the transaction history included in the account profile.

10. The method of claim 1, further comprising:
receiving, by the receiving device, an indication that the absent payment card has been recovered; and
removing, from the account profile, the mapped limited-use controlled payment number such that the limited-use controlled payment number is disabled from use in a payment transaction.

11. A system for processing an account corresponding to a reported absent payment card, comprising:
an account database configured to store an account profile, wherein the account profile includes data related to a payment account and includes at least an account identifier;
a receiving device configured to receive a reporting of an absent payment card, wherein the reporting includes at least the account identifier associated with the absent payment card;
a processing device configured to
identify a limited-use controlled payment number,
map, in the account profile, the identified limited-use controlled payment number to the account identifier, and
store, in the account profile, an indication of the included account identifier as being reported as being absent; and
a transmitting device configured to transmit the identified limited-use controlled payment number as a response to the received reporting.

12. The system of claim 11, wherein
the receiving device is further configured to receive an authorization request for a payment transaction, wherein the authorization request includes the account identifier associated with the absent payment card, and
the transmitting device is further configured to transmit an authorization response indicating denial of the payment transaction.

13. The system of claim 11, wherein
the receiving device is further configured to receive an authorization request for a payment transaction, wherein the authorization request includes the limited-use controlled payment number and transaction data, and
the processing device is further configured to process the payment transaction using the account identifier mapped to the limited-use controlled payment number.

14. The system of claim 11, wherein
the receiving device is further configured to receive an authorization request for a payment transaction, wherein the authorization request includes the limited-use controlled payment number, and
the transmitting device is further configured to transmit a data signal configured to initiate a call between a merchant involved in the payment transaction and a financial institution associated with the account identifier.

15. The system of claim 14, wherein the transmitted data signal is an authorization request including a data field indicating that the call between the merchant and the financial institution is required for authorization.

16. The system of claim 11, wherein the received reporting further includes an indication of the absent payment card as being one of: (i) lost, (ii) stolen, and (iii) left behind.

17. The system of claim 16, wherein the transmitting device is further configured to transmit a data message to a financial institution associated with the absent payment card indicating theft of the payment card if the reporting includes an indication of the payment card as being stolen.

18. The system of claim 11, wherein the limited-use controlled payment number is limited in use by at least one of: transaction amount, merchant identification number, merchant category, geographic location, transaction time and/or date, number of transactions, and product data.

19. The system of claim 11, wherein
the account profile further includes transaction history associated with the related payment account, and
the limited-use controlled payment number is subject to one or more controls, the one or more controls being based on at least the transaction history included in the account profile.

20. The system of claim 11, wherein
the receiving device is further configured to receive an indication that the absent payment card has been recovered, and
the processing device is further configured to remove, from the account profile, the mapped limited-use controlled payment number such that the limited-use controlled payment number is disabled from use in a payment transaction.
